(19) United States
(12) Patent Application Publication
(10) Pub. No.: US 2009/0314808 A1
(43) Pub. Date: Dec. 24, 2009

(54) DELIVERY SYSTEM

(76) Inventors: Leo Clifford Pires, Basking Ridge, NJ (US); Roger Hwang, Maple (CA); Rahul Bose, New Delhi (IN); Santosh Mohapatra, New Delhi (IN)

Correspondence Address: Patterson & Sheridan, LLP - ZEN Design, 3040 Post Oak Boulevard, Suite 1500, Houston, TX, 77056, US

(21) Appl. No.: 12/488,538

(22) Filed: Jun. 20, 2009

Related U.S. Application Data
(60) Provisional application No. 61/074,434, filed on Jun. 20, 2008.

(51) Int. Cl. B67D 5/42; B65D 5/72

(52) U.S. Cl. 222/391; 222/1; 222/571

(57) ABSTRACT

The present invention generally relates to a delivery system for dispensing product(s). More particularly, the present invention relates to a delivery system for dispensing product wherein the system has a dispensing mechanism that prevents oozing out of the product after dispensing occurs. The delivery system comprises a body having at least one cavity for housing the product(s) and a plunger or a piston and rod assembly and a means for actuating the piston assembly wherein the piston assembly has a mechanism of dispensing which has an effective suck back effect.

### CROSS-REFERENCE TO RELATED APPLICATION

This application claims benefit of U.S. Provisional Application Ser. No. 61/074,434, filed Jul. 20, 2008, which is incorporated by reference in its entirety.

### BACKGROUND

1. Field of the Invention

Embodiments of the present invention generally relate to a delivery system for dispensing product(s). More particularly, the present invention relates to a delivery system for dispensing product wherein the system has a dispensing mechanism that prevents oozing out of the product after dispensing occurs.

2. Description of the Related Art

Viscous products exhibit an “oozing out” behavior, when they are actuated out of small applicator orifices. This oozing out occurs as there is a time-lag between the actuation and the total dispensing of the viscous bulk. The higher the viscosity, more is the time-lag and more pronounced is the oozing-out phenomenon. The user finds this very frustrating and they either keep waiting the entire time the product oozes out completely, or they initiate multiple actuations to fasten the process or they shut the cover on the oozing. After repeated usage, all the above adds to a big mess inside the cap and therefore, a dirty and contaminated applicator.

It is therefore desired that delivery devices for such products show suck back effect. Suck Back effect is the ability of a dispensing system to pull back a small fraction of the product dosage, each time the package is actuated. A Suck Back feature will prevent oozing of viscous products by pulling back a fraction of the product, for each time the package is actuated. The effective product dosage is calculated taking into account the suck-back volume.

There are present delivery devices that have a pump assembly showing suck back effect. However, the delivery devices using a plunger/piston assembly are generally found to have an inefficient suck back effect and the oozed product still remains on the applicator.

Therefore, there is a need in the art for a delivery device using a plunger/piston and rod assembly that shows an effective suck back effect such that no oozing out of product occurs.

### SUMMARY

The present invention generally is a delivery system for dispensing product(s). More particularly, the present invention relates to a delivery system for dispensing product wherein the system has a dispensing mechanism that prevents oozing out of the product.

According to an embodiment of the invention there is provided a delivery system for dispensing a product that has a mechanism of dispensing which has an effective suck back effect. The delivery system of the present invention uses a plunger/piston and rod assembly to dispense the product.

In accordance with an embodiment of the invention, the delivery system comprises a body having at least one cavity for housing the product(s) and a plunger or a piston and rod assembly and a means for actuating the piston assembly.

According to yet another embodiment of the invention, the piston assembly comprises of a piston, a piston rod, an anti-slip jaw and a propeller jaw. The terms “Anti-slip jaw” and “Propelling jaw” as used herein refer to a radially symmetrical component with cut outs in the center, said cut-outs defining formation of flanges, said flanges making the jaw to be elastically deformable towards one axis. The piston rod is profiled wherein the profiles serve as appropriate means of engagement with the anti-slip and the propeller jaws. The piston rod may also be profiled in a manner that there are present ratchets on the rod periphery. Further, the profiles on the piston rod are present such that there exists a gap between the two profiles. This gap between the profiles helps in providing a suck back effect.

According to yet another embodiment of the invention, the piston assembly further comprises a stationary holder for holding the anti-slip jaw, a propelling holder that holds the propelling jaw and a biasing member biasing the movement of both the holders and in turn both the jaws. The propeller jaw and the anti-slip jaw control the movement of the piston rod. The stationary holder is so arranged inside the cavity of the body that it remains stationary whereas the propelling holder is arranged to be movable inside the cavity.

In accordance with another embodiment of the invention, as the propelling holder is pushed there occurs simultaneous displacement of the propelling jaw and the piston rod. The anti-slip jaw allows the piston rod to be displaced through it and cause displacement of the piston which causes the fluid to be dispensed. As both the jaws are biased by a biasing member, therefore, the propeller jaw is caused to move back to its initial position after the influence of the force of the biasing member. While the propeller jaw pulls the piston rod back to its initial position, the anti-slip jaw being stationary engages with the profile of the piston rod. However, the gap between the profiles lets the piston rod to move downwards a little before the profile of the piston rod gets fully engaged with the complimentary profile of the flanges of the anti-slip jaw. This results in sucking back of a fraction of the product into the cavity thereby preventing an oozing-out effect. Also, the gap in the profiles on the piston rod may be relatively adjusted for regulating the amount of suck back flow of product.

According to yet another embodiment of the invention, the body of the delivery system may have at least two cavities wherein each of the cavity houses a piston and rod assembly as described above and therefore, helps in preventing oozing out in a multiple compartment delivery system as well.

Delivery system of the present invention may be used in any suitable device for dispensing a wide variety of consumer and industrial products related to cosmetic, skin care, hair care, oral care, personal care, pharmaceutical, wound care, orally administrable products, home-care or adhesives.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a cross-sectional view showing the arrangement of the piston and rod assembly in the delivery system according to an embodiment of the invention.

FIG. 2 is a perspective view of the profiled piston rod of the delivery system as shown in FIG. 1.

FIG. 3 is an enlarged fragmentary view of the arrangement of the profiles on the piston rod of the delivery system as shown in FIG. 2.

FIG. 4 is an exploded view of the delivery system as shown in FIG. 1.

FIG. 5 is a cross-sectional view showing the displacement of the parts of the piston and rod assembly upon actuation of the delivery system as shown in FIG. 1.

FIG. 6 is a cross-sectional view showing the downward movement of the profiled piston rod of the piston and rod assembly after the actuation of the delivery system as shown in FIG. 1.

FIG. 7 is a cross-sectional view showing the engagement of the profiled piston rod with the anti-slip jaw of the piston and rod assembly resulting in suck-back effect in the delivery system as shown in FIG. 1.

To facilitate understanding, identical reference numerals have been used, where possible, to designate identical elements that are common to the figures. It is to be noted, however, that the appended drawings illustrate only typical embodiments of this invention and are therefore not to be considered limiting of its scope, for the invention may admit to other equally effective embodiments.

### DETAILED DESCRIPTION

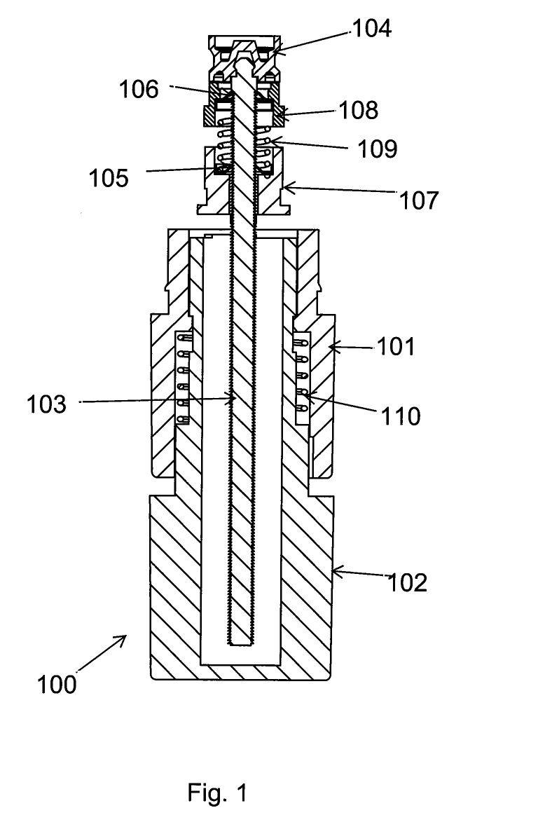

FIG. 1 is one embodiment of the delivery system 100 according to one embodiment of the present invention.

The terms “Anti-slip jaw” and “Propelling jaw” as used herein refer to a radially symmetrical component with cut outs in the center, said cut-outs defining formation of flanges, said flanges making the jaw to be elastically deformable towards one axis.

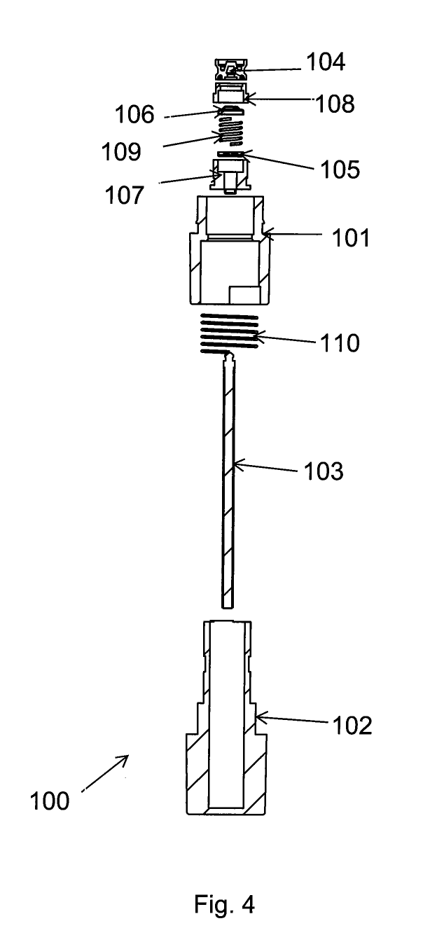

As shown in FIGS. 1 and 4, the delivery system 100 of the present invention comprises a body 101 having a cavity that houses the piston and rod assembly and a means for actuating the piston assembly for example, an actuator 102. The actuator 102 provides the force to actuate the movement of the product in the delivery system 100. The actuator 102 is operatively connected to the body 101. The actuator 102 may be connected to the body 101 by means of a biasing member 110. Further, the body 101 has at least one cavity for housing the product(s) and a piston and rod assembly.

As illustrated in FIGS. 1 and 4, the piston assembly comprises of a piston rod 103, a piston 104, an anti-slip jaw 106 and a propeller jaw 105. The piston assembly also comprises a stationary holder 108 for holding the anti-slip jaw 106, a propelling holder 107 that holds the propelling jaw 105 and a biasing member 109 biasing the movement of both the holders and in turn both the jaws. The propeller jaw 105 and the anti-slip jaw 106 control the movement of the piston rod 103. The stationary holder 108 is so arranged inside the cavity of the body 101 that it remains stationary whereas the propelling holder 107 is arranged to be movable inside the cavity.

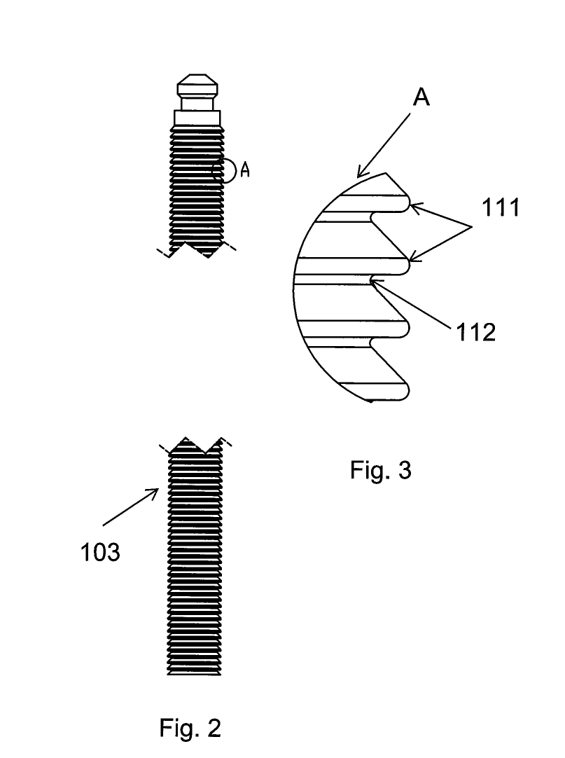

As illustrated in FIGS. 2 and 3, the piston rod 103 is profiled wherein the profiles 111 serve as appropriate means of engagement with the anti-slip jaw 106 and the propeller jaw 105. The profiles 111 on the piston rod 103 are present such that there exists a gap 112 in between the profiles. This gap 112 between the profiles 111 helps in providing a suck back effect.

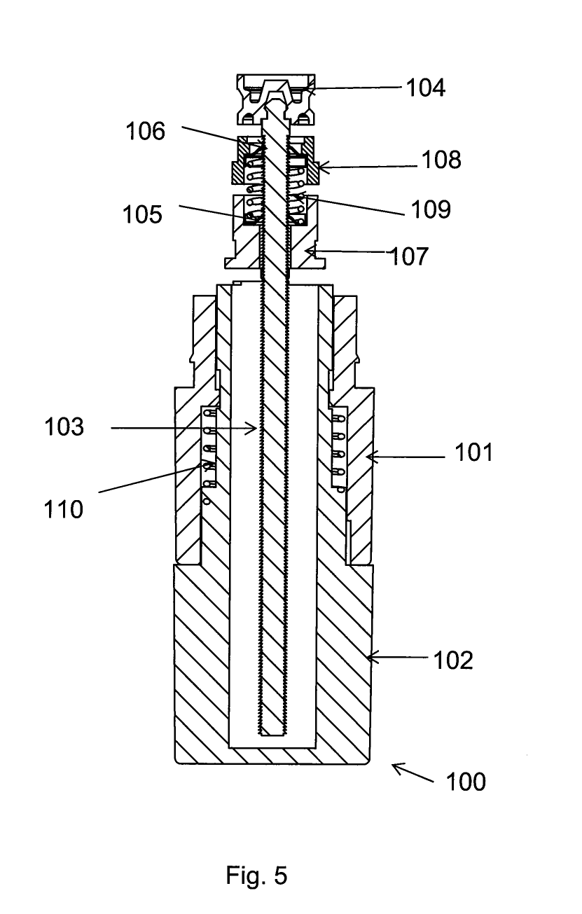

As is represented in FIG. 5, as the propelling holder 107 is pushed by the actuator 102, there occurs simultaneous displacement of the propelling jaw 105 and the piston rod 103. The anti-slip jaw 106 allows the piston rod 103 to be displaced through it and cause displacement of the piston 104 which causes the fluid to be dispensed.

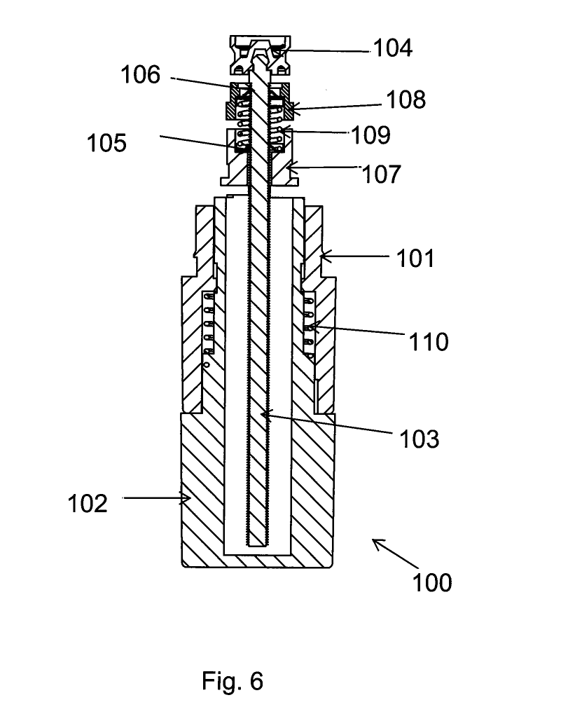

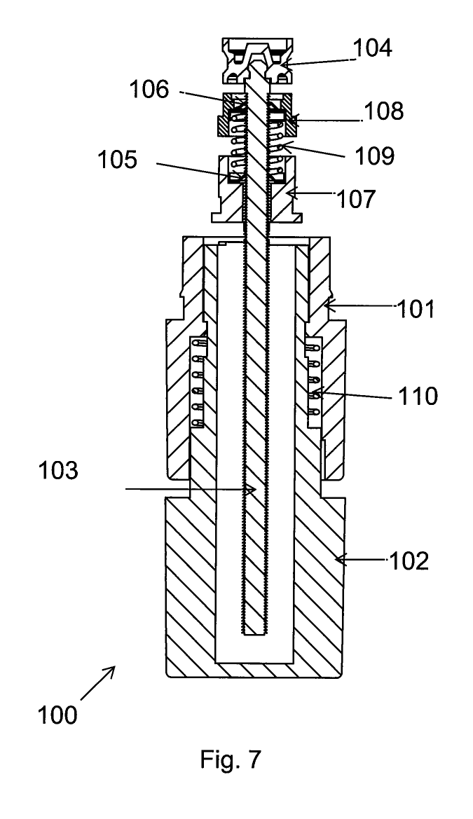

FIG. 6 shows the downward movement of the piston 104 and the piston rod 103. As both the jaws 105 and 106 are biased by a biasing member 109, therefore, the propeller jaw 105 is caused to move back to its initial position after the influence of the force of the biasing member 109. While the propeller jaw 105 pulls the piston rod 103 back to its initial position, the anti-slip jaw 106 being stationary tries to engage with the profiled piston rod 103. FIG. 7 shows the total displacement of the piston 104 and piston rod 103 causing the suck back effect. The gap 112 between the profiles 111 of the piston rod 103 lets the piston rod 103 to move downwards a little before the profile of the piston rod 103 gets fully engaged with the complimentary profile of the flanges of the anti-slip jaw 106. This results in sucking back of a fraction of the product into the cavity thereby preventing an oozing-out effect.

The body 101 of the delivery system 100 may have at least two cavities wherein each of the cavity houses a piston and rod assembly and therefore, helps in preventing oozing out in a multiple compartment delivery system as well.

The body 101 of the delivery system 100 may be formed of a polymeric material such as propylene. The body 101 may have any suitable shape such as cylindrical, rectangular or any other suitable shape. The actuating means/actuator 102 may be formed of styrene acrylonitrile or acrylonitrile butadiene styrene or any suitable polymeric material. The materials suitable for forming the piston rod 103 and the propelling holder 107 and stationary holder 108 may be polyacetal or any other suitable polymeric material. The biasing member 109 may be made of any suitable metal such as steel. The material for forming piston 104 may be any suitable polymeric material such as polypropylene, polyacetal or low-density polyethylene. The aforementioned materials for forming various parts of the delivery system 100 of the present invention are an example, however other suitable materials may also be used.

Delivery system of the present invention may be used to dispense a wide variety of consumer and industrial products related to cosmetic, skin care, hair care, oral care, personal care, pharmaceutical, wound care, orally administrable products, home-care or adhesives. Further, the delivery system of the present invention may be incorporated in any of the suitable devices used for dispensing the aforementioned products.

Various examples of the products where the delivery system of the present invention could be used for dispensing are but not limited to cheek blush, cheek plumping gel/cream, lip plumping gel/cream, moisturizer, sunscreen, temporary hair colors, hair styling gel, hair mousse, hair repair cream, hydrating cream, antiseptic and correction cream, acne treatment cream, concealer, blemish concealer, skin treatment cream, hair repair cream, anti-dandruff cream, hair treatment serum, scalp hydrating oils, teeth whitening gel, teeth whitening and teeth lamination solutions, pain relieving cream, antibiotic cream and analgesic cream, antipyretic and analgesic serums/solutions, bleaching agent, fabric softener, stain remover, bleaching agent, adhesive gels.

The delivery system of present invention could also be used to dispense two products simultaneously wherein the two products dispensed are but not limited to cheek blush with vitamins, cheek blush with cheek plumping gel/cream, lip plumping gel/cream with moisturizer, temporary hair colors, hair styling gel with glitter, hair styling gel with color, hair mousse with hair repair cream, exfoliant with hydrating cream, antiseptic and correction cream, acne treatment cream and concealer, blemish concealer with skin treatment cream, hair repair cream with anti-dandruff cream, hair treatment serum with scalp hydrating oils, teeth whitening gel with mouth wash, teeth whitening and teeth lamination solutions, pain relieving cream with cooling serum, antibiotic cream and analgesic cream, two active antibiotic creams, antipyretic and analgesic serums/solutions, bleaching agent with fabric softener, stain remover with sanitizer, bleaching agent with fragrant solution while in adhesives the two active adhesive gels could be dispensed by the delivery system of the present invention.

While the foregoing is directed to embodiments of the present invention, other and further embodiments of the invention may be devised without departing from the basic scope thereof, and the scope thereof is determined by the claims that follow.

What is claimed is:

1. A delivery system comprising:
a body having at least one cavity for housing one or more products and a piston and rod assembly; wherein the piston assembly comprises of a piston, a piston rod, an anti-slip jaw and a propeller jaw; and
a means for actuating the piston assembly; wherein the piston rod is profiled and wherein there is present a gap between the profiles on the piston rod to provide a suck back effect.

2. The delivery system according to claim 1, wherein the profiles on the piston rod are in the form of ratchets on the piston rod periphery.

3. The delivery system according to claim 2, wherein the anti-slip jaw and the propeller jaw comprise a radially symmetrical component with cut outs in the center, said cut-outs defining formation of flanges, said flanges making the propeller jaw to be elastically deformable towards one axis.

4. The delivery system according to claim 3, wherein the anti-slip jaw and the propeller jaw engage with the profiles on the piston rod.

5. The delivery system according to claim 4, wherein there exists a gap between the two profiles on the piston rod said gap contributing to the suck back effect.

6. The delivery system according to claim 5, wherein the piston assembly further comprises a stationary holder that holds the anti-slip jaw, a propelling holder that holds the propelling jaw and a biasing member biasing the movement both the holders and in turn both the jaws.

7. The delivery system according to claim 6, wherein the stationary holder is arranged to remain stationary inside the cavity of the body and the propelling holder is arranged to be movable inside the cavity.

8. The delivery system as claimed in claim 7, wherein the body of the cavity houses at least two cavities wherein each of the cavity houses a piston and rod assembly and therefore, helps in preventing oozing out in a multiple compartment delivery system.

9. The delivery system as claimed in claim 1, wherein the system is used to dispense a variety of consumer and industrial products related to cosmetic, skin care, hair care, oral care, personal care, pharmaceutical, wound care, orally administrable products, home-care or adhesives.

10. A method for providing suck back effect using the delivery system as claimed in 7.

11. The method according to claim 10 comprising
actuating the actuating means to dispense the fluid wherein the actuation causes displacement of propelling holder thereby causing simultaneous displacement of the propelling jaw and the piston rod, said piston rod being displaced through the anti-slip jaw to cause displacement of the piston which causes the fluid to be dispensed; and
simultaneous sucking back of a fraction of the product in the cavity, wherein the suck back method comprises displacement of the piston rod and the propeller jaw to their initial position after pushing the piston under the action of the force of the biasing member disposed between the propeller jaw and the anti-slip jaw wherein the profile on the piston rod engages with the profiled flange of the stationary anti-slip jaw wherein the gap between the profiles lets the piston rod to move downwards a little before the profile of the piston rod gets fully engaged with the complimentary profile of the flanges of the anti-slip jaw.

12. The method as claimed in claim 11 prevents oozing out of excess product.

13. The method as claimed in claim 12 wherein the gap in the profiles on the piston rod is relatively adjusted for regulating the amount of suck back flow of product.

14. A delivery system comprising:
a body having at least one cavity for housing products and a piston assembly, wherein the piston assembly comprises of a piston, a piston rod, an anti-slip jaw and a propeller jaw; and
a means for actuating the piston assembly, wherein the piston rod is profiled and wherein there is present a gap between the profiles on the piston rod to provide a suck back effect, wherein the profiles on the piston rod are in the form of ratchets on the piston rod periphery, wherein the anti-slip jaw and the propeller jaw comprise a radially symmetrical component with cut outs in the center, said cut-outs defining formation of flanges, said flanges making the jaw to be elastically deformable towards one axis, wherein the anti-slip jaw and the propeller jaw engage with the profiles on the piston rod, wherein there exists a gap between the two profiles on the piston rod said gap contributing to suck back effect, wherein the piston assembly further comprises a stationary holder that holds the anti-slip jaw, a propelling holder that holds the propelling jaw and a biasing member biasing the movement of both of the holders and in turn both of the jaws, wherein the stationary holder is arranged to remain stationary inside the cavity of the body and the propelling holder is arranged to be movable inside the cavity.
